(19) United States
(12) Patent Application Publication
(10) Pub. No.: US 2014/0341206 A1
(43) Pub. Date: Nov. 20, 2014

(54) METHOD FOR TIME SYNCHRONIZATION OF NODES IN PEER AWARE COMMUNICATION ENVIRONMENT

(71) Applicant: Electronics and Telecommunications Research Institute, Daejeon (KR)

(72) Inventors: Chang Sub SHIN, Daejeon (KR); Wun-Cheol JEONG, Daejeon (KR); Tae Joon PARK, Daejeon (KR); Hoyong KANG, Daejeon (KR); Cheol Sig PYO, Daejeon (KR)

(73) Assignee: Electronics and Telecommunications Research Institute, Daejeon (KR)

(21) Appl. No.: 14/278,340

(22) Filed: May 15, 2014

(30) Foreign Application Priority Data
May 14, 2013 (KR) 10-2013-0054565
Apr. 28, 2014 (KR) 10-2014-0050938

(51) Int. Cl. H04J 3/06; H04W 74/04; H04W 56/00

(52) U.S. Cl. CPC H04J 3/0673; H04W 56/001; H04W 74/04; H04W 84/18
USPC 370/350

(57) ABSTRACT

According to an exemplary embodiment of the present invention, a method for time synchronization of a first node in a peer aware communication (PAC) environment is provided. The first node obtains medium access control authority by performing contention with a second node neighboring the first node. The first node adds a time synchronization offset to the first beacon frame. In addition, the first node transmits the first beacon frame in a beacon period of a superframe when obtaining the media access control authority.

### CROSS-REFERENCE TO RELATED APPLICATION

This application claims priority to and the benefit of Korean Patent Application Nos. 10-2013-0054565, and 10-2014-0050938 filed in the Korean Intellectual Property Office on May 14, 2013, and Apr. 28, 2014, the entire contents of which are incorporated herein by reference.

### BACKGROUND OF THE INVENTION

(a) Field of the Invention

The present invention relates to a method for time synchronization of nodes in a peer aware communication (PAC) environment.

(b) Description of the Related Art

In a recent industry field, there is a need for services of direct communication between nodes and group communication between the nodes, which are performed without using an infrastructure connection. Because it is difficult to apply an existing wireless medium access method to the direct communication between the nodes and the existing wireless medium access method is operated in a centralized method, it is difficult to support the aforementioned services using the existing wireless medium access method.

According to the existing wireless medium access method, a main coordinator connected to an infrastructure network manages all resources. Thus, in order to perform the direct communication between the nodes, the nodes should be assigned the resource from the main coordinator. According to the existing wireless medium access method, because wireless access may not be controlled in the case in which the main coordinator is not present, it is difficult to support the aforementioned services using the existing wireless medium access method. Further, according to the existing wireless medium access method, it is difficult to maintain a synchronization signal in an environment having severe channel interference.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for time synchronization of nodes in a peer aware communication environment having advantages of a wireless medium access method being capable of supporting direct communication between nodes and group communication between the nodes while not being based on an infrastructure.

Further, the present invention has been made in an effort to provide a method for time synchronization of nodes in a peer aware communication environment having advantages of being a method capable of maintaining synchronization between nodes in an environment having frequent channel interference.

An embodiment of the present invention provides a method for time synchronization of a first node in a peer aware communication (PAC) environment. The method may include obtaining, by the first node, medium access control authority by performing contention with a second node neighboring the first node; adding a time synchronization offset to a first beacon frame; and transmitting the first beacon frame in a beacon period of a superframe when the medium access control authority is obtained.

The superframe may include: a contention period including the beacon period and a control period having a termination point of time of the beacon period as a start point of time; and a contention free period including a plurality of channels.

A duration of the contention period may be defined by the number of time slots, and may be variable.

The beacon period may include at least one channel.

The transmitting of the first beacon frame may include transmitting the first beacon frame over a second channel that is different from a first channel among channels of the beacon period when a second beacon frame is received over the first channel among the channels of the beacon period from the second node.

The method may further include transmitting a control message to the second node in the control period.

The obtaining of the medium access control authority may include performing contention with the second node using a back-off algorithm having a contention window value which is equal to or less than a first value.

Another embodiment of the present invention provides a method for time synchronization of a first node in a peer aware communication environment. The method may include: forming, by the first node and at least one node neighboring the first node, a group; transmitting a beacon frame to the group over a first channel among a plurality of channels included in a beacon period of a superframe; and transmitting a control message over the first channel among channels included in a control period of the superframe.

The first channel may be a frequency resource.

The method may further include: forming a channel list including at least one among channels of the contention free period; and transmitting data over channels included in the channel list.

Yet another embodiment of the present invention provides a method for time synchronization of a first node in peer aware communication. The method may include: receiving a first beacon frame from a second node over a first channel among a plurality of channels included in a beacon period of a superframe; and forwarding the first beacon frame to a third node having a multi-hop relationship with the second node over a second channel that is different from the first channel among a plurality of channels included in the beacon period.

The method may further include: forming a channel list including at least one among channels of the contention free period; and transmitting data over the channels included in the channel list.

The forming of the channel list may include allowing a channel that is different from a channel used to transmit data by the second node among channels of the contention free period to be included in the channel list.

### BRIEF DESCRIPTION OF THE DRAWINGS

FIG. 1 is a drawing showing a structure of a superframe according to an exemplary embodiment of the present invention.

FIG. 2 is a drawing showing a structure of a superframe according to another exemplary embodiment of the present invention.

FIG. 3 is a drawing showing a method for time synchronization in a distribution scheme according to an exemplary embodiment of the present invention.

FIG. 4 is a drawing showing a node group topology according to an exemplary embodiment of the present invention.

FIG. 5 is a drawing showing a method for transmitting a beacon based on contention between nodes within a group according to an exemplary embodiment of the present invention.

FIG. 6 is a drawing showing a multi-hop group topology according to an exemplary embodiment of the present invention.

FIG. 7 is a drawing showing a method for multi-hop synchronization transmission and a method for using a superframe according to an exemplary embodiment of the present invention.

FIG. 8 is a drawing showing a configuration of a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a node may refer to a terminal, a mobile terminal (MT), a mobile station (MS), an advanced mobile station (AMS), a high reliability mobile station (HR-MS), a subscriber station (SS), a portable subscriber station (PSS), an access terminal (AT), user equipment (UE), or the like, and may include all or some of the functions of the terminal, MT, MS, AMS, HR-MS, SS, PSS, AT, UE, or the like.

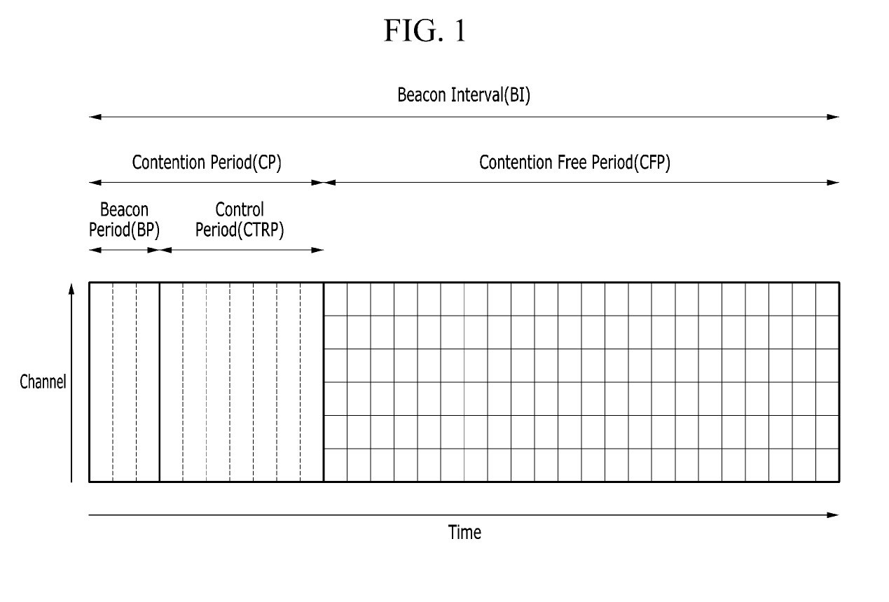

FIG. 1 is a drawing showing a structure of a superframe according to an exemplary embodiment of the present invention.

The superframe is a medium access control frame of a medium access control (MAC) layer supporting a synchronization scheme. In FIG. 1, a horizontal axis represents a time Time and a vertical axis represents a channel (frequency).

Specifically, the superframe is comprised of time slots, wherein the number of time slots configuring the superframe may be variable. A duration of the superframe may be represented by a beacon interval (BI), which is an interval between a beacon frame and a next beacon frame. Meanwhile, the superframe includes a contention period (CP) and a contention free period (CFP). A duration of each of the contention period (CP) and the contention free period (CFP) may be defined by the number of time slots, and may be variable. Meanwhile, the contention period (CP) includes a beacon period (BP) and a control period (CTRP). The control period starts from a point of time at which the beacon period (BP) is terminated. The contention period (CP) may be composed of a single channel, and the contention free period (CFP) may be comprised of a multi-channel. Meanwhile, a duration of the time slot (TimeSlotDuration) may be defined by the following Equation 1.

TimeSlotDuration=baseTimeSlotDuration×m [Equation 1]

In Equation 1, 1≦m≦10, and baseTimeSlotDuration is a constant.

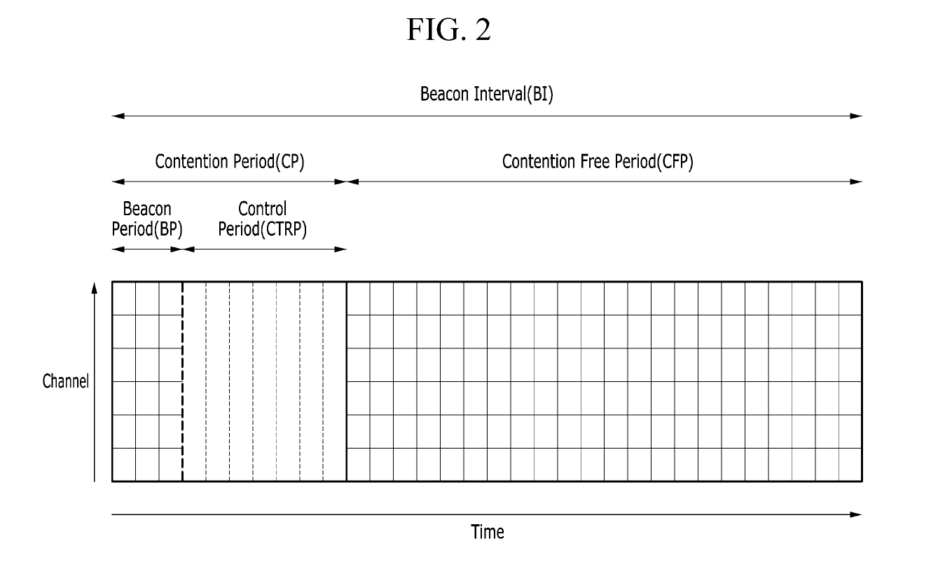

FIG. 2 is a drawing showing a structure of a superframe according to another exemplary embodiment of the present invention. Specifically, FIG. 2 is a drawing showing a structure of an expanded superframe.

The expanded superframe of FIG. 2 is different from the superframe of FIG. 1 in that the beacon period (BP) is composed of the multi-channel.

In the structure of the expanded superframe, each node may transmit a beacon signal over channels (or frequencies) that are different from each other. Specifically, in the case in which any one node of a multi-hop group, which is a group composed of nodes having a multi-hop relationship, needs to retransmit the beacon signal, the node may receive the beacon signal from a parent node and then transmit the beacon signal over an available channel that is different from the channel receiving the beacon signal.

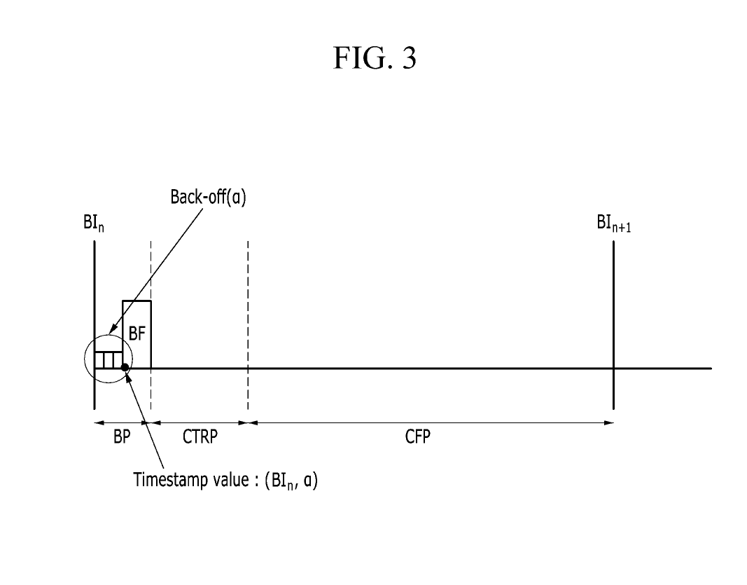

FIG. 3 is a drawing showing a method for time synchronization in a distribution scheme without having an infrastructure connection according to an exemplary embodiment of the present invention. Specifically, FIG. 3 shows a method in which a node implements time synchronization with another node to perform direct communication between the nodes or group communication between the nodes using a beacon frame (or beacon signal) in a peer aware communication (PAC) environment in which the communication is performed between the nodes without using the infrastructure. According to the method for the time synchronization illustrated in FIG. 3, either one of the superframe of FIG. 1 and the expanded superframe of FIG. 2 may be used.

Specifically, the node obtains medium access control authority through contention with peripheral nodes in the beacon period (BP). In addition, the node obtaining the medium access control authority transmits a beacon frame (BF). In this case, because the peripheral nodes have the control period (CTRP) started from immediately after receiving the beacon frame (BF), the peripheral nodes may transmit and receive a control message to and from another node.

Meanwhile, a contention scheme between the nodes in the beacon period (BP) may be based on a back-off algorithm, wherein a range of a contention window value may be set as small as possible. Specifically, the node may perform the contention with another node using the back-off algorithm having a contention window value which is equal to or less than a first value in order to obtain the medium access control authority.

Meanwhile, a time synchronization error may be increased due to a transmission delay which may be caused in the case in which the beacon frame BF is transmitted based on the contention. In order to minimize the time synchronization error, the node may add a time synchronization offset value α to the beacon frame (BF) and transmit the beacon frame (BF) having the time synchronization offset value α added thereto. Specifically, the beacon frame (BF) may include (BIₙ, α), which is a timestamp value representing a time at which the beacon frame (BF) is transmitted. BIₙ represents an n-th BI, and BIₙ₊₁ represents an (n+1)-th BI. The node receiving the beacon frame (BF) may compensate the time synchronization offset value α included in the received beacon frame (BF). Specifically, the node receiving the beacon frame (BF) may adjust the time synchronization using (BIₙ, α), which is the timestamp value and the time at which the beacon frame (BF) is received. By the above-mentioned configuration, precise time synchronization between the nodes may be implemented. Here, the time synchronization offset value α may represent a delayed time based on a transferred synchronization time value. The node receiving the beacon frame (BF) may perform the precise time synchronization by taking into account a delayed time value using the time synchronization offset value α.

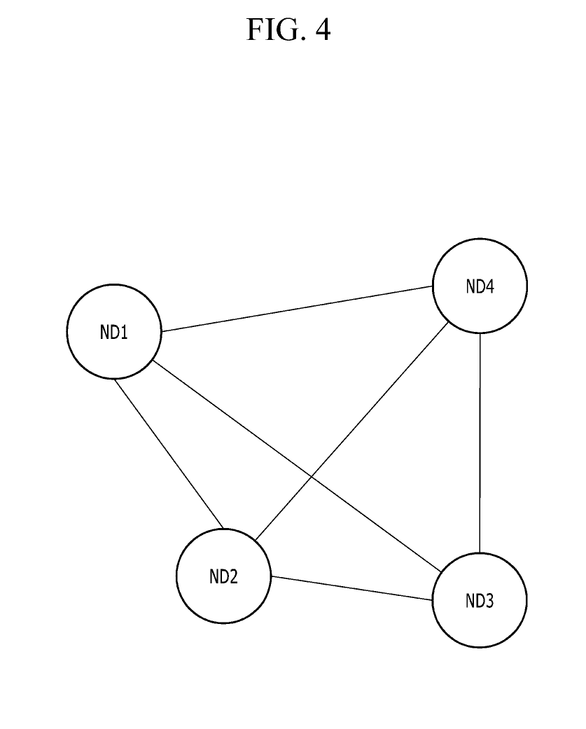

FIG. 4 is a drawing showing a node group topology according to an exemplary embodiment of the present invention.

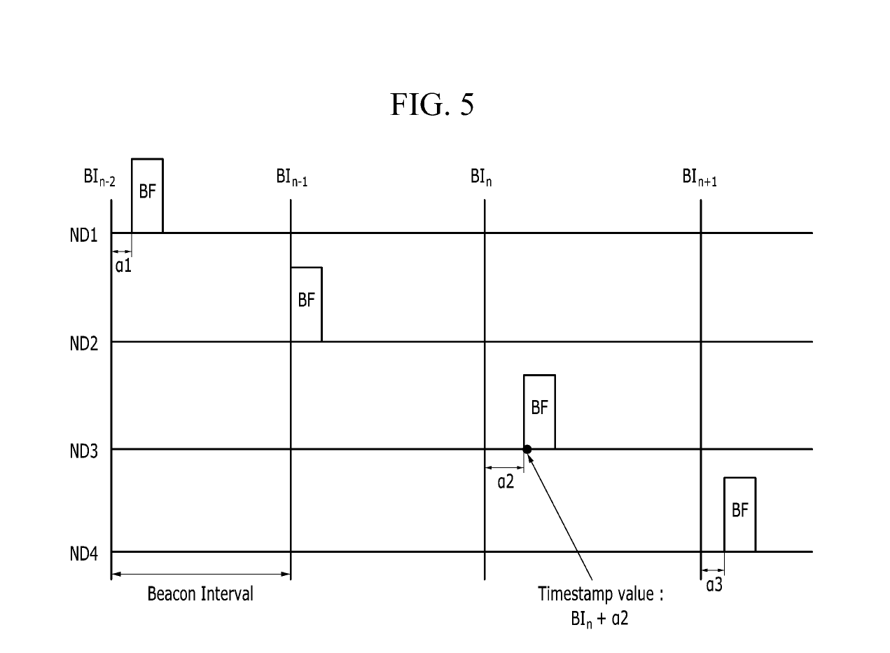

As shown in FIG. 4, nodes (ND1 to ND4) may have a one-hop relationship with each other and may form a group. Even though any one node (e.g., ND1) leaves from the node group illustrated in FIG. 4, the time synchronization between the remaining nodes (ND2 to ND4) may be maintained. A method for maintaining a time synchronization signal by the node group of FIG. 4 will be described in detail with reference to FIG. 5.

FIG. 5 is a drawing showing a method for transmitting a beacon based on contention between nodes within a group according to an exemplary embodiment of the present invention.

All nodes (ND1 to ND4) participating in the group of FIG. 4 obtain a beacon transmission opportunity through a contention in the beacon period (BP). The nodes which do not obtain the beacon transmission opportunity may enter a beacon reception state to thereby receive the beacon frame (BF) transmitted by the node obtaining the beacon transmission opportunity. For example, as shown in FIG. 5, the node (ND1) obtaining the beacon transmission opportunity through the contention may transmit the beacon frame (BF) at a point of time at which a time synchronization offset value α1 has elapsed from a start point of time of BIₙ₋₂, which is an (n−2)-th BI. In addition, the node (ND2) obtaining the beacon transmission opportunity through the contention may transmit the beacon frame (BF) at a start point of time of BIₙ₋₁, which is an (n−1)-th BI. In addition, the node (ND3) obtaining the beacon transmission opportunity through the contention may transmit the beacon frame (BF) at a point of time at which a time synchronization offset value α2 has elapsed from a start point of time of BIₙ, which is an n-th BI. Here, the node (ND3) may allow BIₙ+α2 as the timestamp value to be included in the beacon frame (BF). In addition, the node (ND4) obtaining the beacon transmission opportunity through the contention may transmit the beacon frame (BF) at a point of time at which a time synchronization offset value α3 has elapsed from a start point of time of BIₙ₊₁, which is an (n+1)-th BI. As such, because all nodes (ND1 to ND4) transmit the beacon frame (BF) through the contention, even though any one node (e.g., ND1) arbitrarily leaves from the group, the synchronization of the group may be continuously maintained.

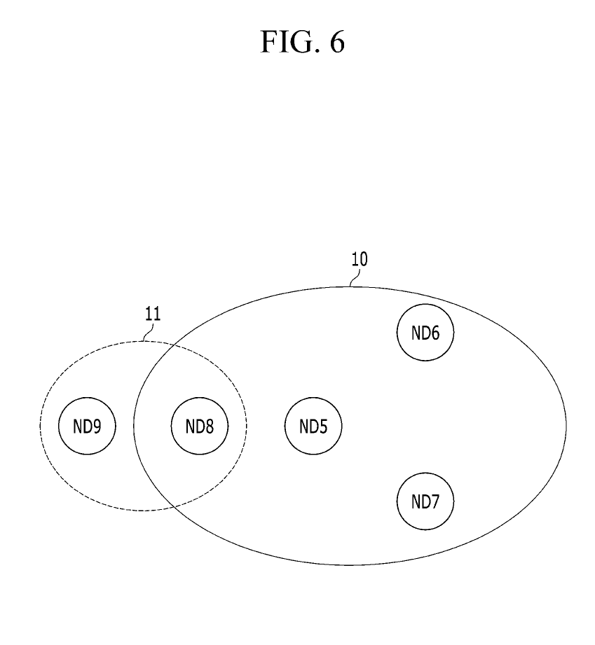

FIG. 6 is a drawing showing a multi-hop group topology according to an exemplary embodiment of the present invention.

Specifically, a node (ND5) may form a group together with nodes (ND6 to ND8) in a region 10. In addition, the node (ND5) may transmit the beacon frame to the nodes (ND6 to ND8) to start data transmission between the nodes (ND5 to ND8).

Meanwhile, the node (ND8) receiving the beacon frame from the node (ND5) may forward the received beacon frame to a node (ND9) in a region 11. As a result, the node (ND9) may be time-synchronized with other nodes (ND5 to ND8) in the region 10. That is, the node (ND9) may be time-synchronized with the nodes (ND5 to ND7) having a multi-hop relationship.

Meanwhile, the nodes (ND5 to ND9) in the multi-hop group may obtain the medium access control authority (beacon frame transmission authority) through the contention, as described above.

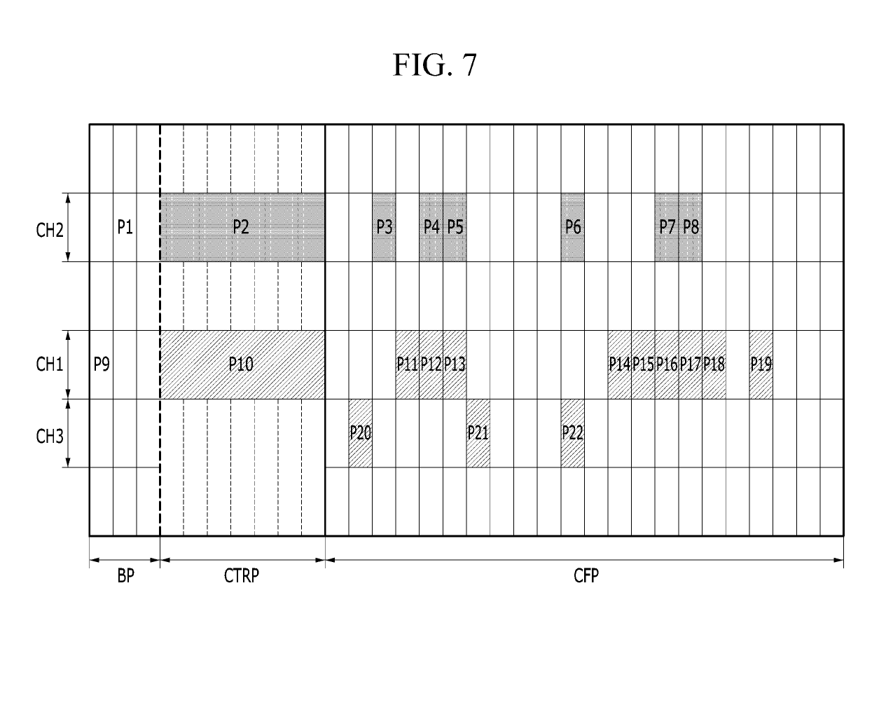

Meanwhile, a method for transmitting a synchronization signal by the multi-hop group of FIG. 6 and a method for using the superframe will be described in detail with reference to FIG. 7.

FIG. 7 is a drawing showing a method for multi-hop synchronization transmission and a method for using a superframe according to an exemplary embodiment of the present invention. FIG. 7 illustrates a case in which the multi-hop group of FIG. 6 uses the expanded superframe of FIG. 2.

The node (ND5) selects a channel (CH1) among available channels included in the beacon period (BP) in order to transmit the beacon frame. For example, the node (ND5) may transmit the beacon frame in any one period (P9) among periods corresponding to the channel (CH1) in the beacon period (BP).

The node (ND8) neighboring the node (ND5) may forward the beacon frame received from the node (ND5) to the node (ND9) in a channel (CH2) different from the channel (CH1) among the available channels included in the beacon period (BP). For example, the node (ND8) may transmit the beacon frame in any one period (P1) among periods corresponding to the channel (CH2) in the beacon period (BP). As a result, the time synchronization (signal) may also be maintained in a multi-hop environment.

Meanwhile, each of the node (ND5) and the node (ND8) transmitting the beacon frame starts the control period (CTRP) in the channels (CH1 and CH2) transmitting the beacon frame. For example, the node (ND5) may transmit the control message in a period (P10) corresponding to the channel (CH1) in the control period (CTRP). The same frequency resource may be used in the period (P9) and the period (P10). In addition, the node (ND8) may transmit the control message in a period (P2) corresponding to the channel (CH2) in the control period (CTRP).

Meanwhile, each of the node (ND5) and the node (ND8) transmitting the beacon frame may form an available channel list including at least one available channel among channels in a contention free period (CFP). Each of the node (ND5) and the node (ND8) may transmit data over the available channels included in the available channel list for data transmission. For example, the node (ND5) may allow the channel (CH1) and a channel (CH3) among the available channels included in the contention free period (CFP) to be included in the available channel list. More specifically, the node (ND5) may allow periods (P11 to P19) among periods corresponding to the channel (CH1) and periods (P20 to P22) among periods corresponding to the channel (CH3) within the contention free period (CFP) to be included in the available channel list. In addition, the node (ND8) may allow the channel (CH2) among the available channels included in the contention free period (CFP) to be included in the available channel list. More specifically, the node (ND8) may allow periods (P3 to P8) among periods corresponding to the channel (CH2) within the contention free period (CFP) to be included in the available channel list.

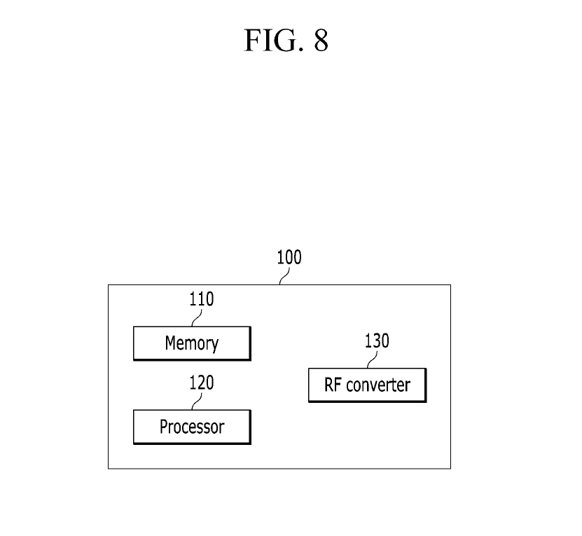

FIG. 8 is a drawing showing a configuration of a node 100 according to an exemplary embodiment of the present invention.

The nodes (ND1 to ND9) may have configurations which are the same as or similar to a configuration of the node 100.

Specifically, the node 100 may include a memory 110, a processor 120, and a radio frequency (RF) converter 130.

The processor 120 may be configured to implement procedures, methods, and functions related to the nodes (ND1 to ND9) described in FIGS. 1 to 7.

The memory 110 may be connected to the processor 120 and may store various data related to an operation of the processor 120.

The RF converter 130 may be connected to the processor 120 and may transmit or receive a wireless signal. In addition, the node 100 may have a single antenna or multiple antennas.

According to an embodiment of the present invention, time synchronization between the nodes performing direct communication or group communication may be implemented without using the main coordinator, that is, without the aid of the node connected to the infrastructure network.

According to an embodiment of the present invention, the method for time synchronization in the distribution scheme for the direct communication between the nodes or the group communication between the nodes may be supported through the superframe structure.

According to an embodiment of the present invention, a service having high reliability may be provided and service faults may be efficiently solved through the method for the time synchronization in the distribution scheme.

According to an embodiment of the present invention, a stable synchronization signal may be maintained by transmitting the beacon signal based on the contention in an environment having severe radio interference.

According to an embodiment of the present invention, all nodes in the group transmit the beacon signal through the contention upon transmitting the beacon signal, such that the synchronization signal may be continuously maintained even though the participating node arbitrarily leaves from the group.

Further, according to an embodiment of the present invention, many nodes may be accommodated in the group by using the multi-channel in the beacon period in the case in which the group is formed in the multi-hop scheme. In addition, according to an embodiment of the present invention, the use of the multi-channel in the beacon period may be supported by the superframe structure which may be easily expanded and have various configurations.

Further, according to an embodiment of the present invention, reliability of data transmission may be improved by using the available multi-channel.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for time synchronization of a first node in a peer aware communication (PAC) environment, the method comprising:
obtaining, by the first node, medium access control authority by performing contention with a second node neighboring the first node;
adding a time synchronization offset to a first beacon frame; and
transmitting the first beacon frame in a beacon period of a superframe when the medium access control authority is obtained.

2. The method of claim 1, wherein
the superframe includes:
a contention period including the beacon period and a control period having a termination point of time of the beacon period as a start point of time; and
a contention free period including a plurality of channels.

3. The method of claim 2, wherein
a duration of the contention period is defined by the number of time slots, and is variable.

4. The method of claim 3, wherein
the beacon period includes at least one channel.

5. The method of claim 4, wherein
the transmitting of the first beacon frame includes
transmitting the first beacon frame over a second channel that is different from a first channel among channels of the beacon period when a second beacon frame is received over the first channel among the channels of the beacon period from the second node.

6. The method of claim 4, further comprising
transmitting a control message to the second node in the control period.

7. The method of claim 4, wherein
the obtaining of the medium access control authority includes
performing contention with the second node using a back-off algorithm having a contention window value which is equal to or less than a first value.

8. A method for time synchronization of a first node in a peer aware communication environment, the method comprising:
forming, by the first node and at least one node neighboring the first node, a group;
transmitting a beacon frame to the group over a first channel among a plurality of channels included in a beacon period of a superframe; and
transmitting a control message over the first channel among channels included in a control period of the superframe.

9. The method of claim 8, wherein
the first channel is a frequency resource, and
the superframe includes:
a contention period including the beacon period and the control period; and
a contention free period including a plurality of channels.

10. The method of claim 9, further comprising:
forming a channel list including at least one among channels of the contention free period; and
transmitting data over channels included in the channel list.

11. The method of claim 10, wherein
the transmitting of the beacon frame includes
obtaining medium access control authority by performing contention with the group.

12. The method of claim 11, wherein
the transmitting of the beacon frame further includes:
adding a time synchronization offset to the beacon frame; and
transmitting the beacon frame over the first channel using the medium access control authority.

13. A method for time synchronization of a first node in a peer aware communication, the method comprising:
receiving a first beacon frame from a second node over a first channel among a plurality of channels included in a beacon period of a superframe; and
forwarding the first beacon frame to a third node having a multi-hop relationship with the second node over a second channel that is different from the first channel among a plurality of channels included in the beacon period.

14. The method of claim 13, wherein
the first channel and the second channel have frequencies that are different from each other, and
the forwarding of the first beacon frame includes:
obtaining medium access control authority through contention with the second node; and
forwarding the first beacon frame using the medium access control authority.

15. The method of claim 13, wherein
the superframe includes:
a contention period including the beacon period and a control period having a termination point of time of the beacon period as a start point of time; and
a contention free period including a plurality of channels.

16. The method of claim 15, wherein
the first beacon frame includes a time synchronization offset.

17. The method of claim 16, further comprising
transmitting a control message over the second channel among channels included in the control period.

18. The method of claim 17, further comprising:
forming a channel list including at least one among channels of the contention free period; and
transmitting data over channels included in the channel list.

19. The method of claim 18, wherein
the forming of the channel list includes
allowing a channel that is different from a channel used to transmit data by the second node among channels of the contention free period to be included in the channel list.

20. The method of claim 19, wherein
a duration of each of the contention period and the contention free period is defined by the number of time slots, and is variable.
